(19) United States
(12) Patent Application Publication
(10) Pub. No.: US 2011/0088222 A1
(43) Pub. Date: Apr. 21, 2011

(54) WIRE PAPER CLIP AND LOOSE-LEAF PAPER HANDLING DEVICES

(76) Inventor: Shoui Tsai, Minneapolis, MN (US)

(21) Appl. No.: 12/161,745

(22) PCT Filed: Jan. 23, 2007
(86) PCT No.: PCT/US07/60937

§ 371 Date: Aug. 4, 2010

Related U.S. Application Data
(60) Provisional application No. 60/761,161, filed on Jan. 23, 2006.

(51) Int. Cl. B42F 1/06

(52) U.S. Cl. 24/67.9

(57) ABSTRACT

A paper clip formed of a single length of wire includes a cross-armed spine that can expand to accommodate increased thicknesses of stacks of loose-leaf paper without loss of gripping strength. A pair of longer arms and a single U-shaped shorter arm are on opposide sides of the stack of paper. The preferred construction uses coated wire.

### CROSS-REFERENCE TO RELATED APPLICATION

This application claims the benefit of provisional application No. 60/761,161 filed Jan. 23, 2006.

### FIELD OF THE INVENTION

This invention concerns paper clips and devices for handling loose-leaf paper.

### BACKGROUND

The common paper clip, also known as Gem clip, was invented in the late nineteenth century. Over the years, countless people had tried to improve it, and many of them had successfully applied for patents for their improvements. However, the Gem clip is still going strong on the stationery market. It was touted as the exemplary design of simplicity and functionality in many publications, including the Early Office Museum Online. See http://www.officemuseum.com/paper_clips.htm.

The museum article listed eight characteristics that are desirable on the paper clip design, which I quoted as follow:

1. Does not catch, mutilate, or tear papers.

2. Does not become tangled with other clips in the box.

3. Holds a thick set of papers.

4. Hold paper securely.

5. Ts thinner and takes less space in files.

6. Is easily inserted

7. Is lightweight and requires less postage.

8. Is cheap (because it uses less wire).

These were indeed a comprehensive description of a perfect paper clip. Most of the inventors managed to improve the paper clip in some aspects, but almost always lose out on a few others. In fact, over the decades, hardly any of these alleged “improvements” amounted to much of a challenge to the dominant position of the Gem clip. In my personal opinion, most of these inventors simply failed to understand the underlying mechanism (the forces at work) of their own design. The Gem clip was far from perfect. As we all knew, applying the Gem clip to just a few sheets of paper, and the wire could no longer stay flat and cling to the paper. Such a distortion was not just an annoyance, it caused a significant loss in clamping force.

The second most popular paper clip on the market is no doubt the binder clip. With its high-resilient sheet-steel body and its thick steel wire handles, the binder clip certainly provided impressive clamping power that no wire clip could match. Then again, the binder clip had a lot of serious flaws. As a long time user, I did appreciate its ability to secure a thick stack of paper. However, I was also quite familiar with the frustration that came with using it. The sheet metal body was too bulky, and the two thick wire-handles are always a nuisance when you tried to leaf through the pages. However, since no better alternative was available, I still used it years after years.

A Japanese inventor, Mihashi Yoshio (patent number JP8142560) did make some improvements on the binder clip in 1996. He disposed of the wire handle and made it much less bulky and less intrusive. He designed a mechanical dispenser to apply the clips automatically. It is quite handy and was available in the stationery stores, but it gradually disappeared from the market place. The US patent was not pursued probably because it turned out to be a marketing failure. I could really appreciate the compact design of this clamshell clip, but the need to carry the dispenser around all the time was just too much of an inconvenience.

The three clips mentioned above were what I was trying to emulate. As a matter of fact, my objective was to design a wire clip with the simplistic beauty of a Gem clip, the generous capacity of a binder clip, and the compact neatness of a clamshell clip. To be more precisely, I wanted to design a wire clip that would accommodate snugly a very thick stack (of up to 100+ sheets) of papers securely and with minimal distortion. That was indeed a daring exploit that no wire-clip inventor ever dreamed of trying.

### PRIOR ART

The earliest paper clip was patented by Samuel B. Fay in 1867, as was indicated in the museum article. It was a very simple design with a piece of wire bent at two spots to create a pair of crossed arms with a straight spine. Another paper clip patent was issued to Reeve in 1897. This one had a round spine and two bent-arms that pointing outward. (Please refer to the museum article for the drawings of all the prior arts without a patent or application number.)

As we all had done in our school days, when we carried the books under the arm, we usually bent the arm to squeeze the books a little so they were held more securely. Therefore, the Reeve version was a small improvement over the Fay version. However, when we squeezed the books with the forearm, the body would provide the counter-force and secure the holding. But the Reeve version did not provide any support for the bent-arms on the other side of the paper stack. So, the actual improvement was minimal.

The first double spine paper clip patent was issue to Cole in 1897. It was a rather crude rendition of a paper clip. At about the same time, the Niagara Clip Co. of New York, N.Y. applied for a patent for its paper clip by joining together two Fay paper clips. And in 1899, the Clipper Mfg. Co. of Long Island, N.Y. patented a very similar clip. Theoretically, these double spine clips should have double strength, but they all failed because of basic designing flaws.

In 1898, the ubiquitous Gem clip started to appear on newspaper ads. The Gem clip was designed with two long U-shaped arms. Throughout this application, I would refer to the curved section that joined the two arms as the spine. I would refer to the straight section of the wire that was connected to the spine as the upper arm, the bent back wire end section as the bent-arm, and the curved section between the upper arm and the bent-arm as the bight. Notice that the spine and the bights, being much shorter than the arms, were less likely to deform when forces were applied on them. Besides, the curvature also gives them added strength. (Cases in point: corrugated iron, corrugated cardboard.)

Straight off the box, the Gem clip could lie flat on a single plane. But when a stack of paper was inserted between the arms, the spine would take up a plane at an angle to the paper stack. It follows naturally that the bights will try to stay on the same plane as the spine. If no resistance force is encountered, (imagine the paper turned into jelly except at the edge,) the bent arms would sink deep into the paper. But in reality, the bent-arms would be pushed out of the paper surface entirely. Meanwhile, since the bights would still try to maintain the same plane as the spine, and they would lift the long upper arms up, which seemed to offer little resistance.

The elongated shape of the Gem clip, with one arm a-third longer than the other, was designed mainly to make paper insertion easier. Many of the latter inventors just followed the lead and designed their invention in the same long pattern. But unfortunately, the long arms were also the major culprits of the serious distortion. To make the clip smaller would usually create new problems for the handling and insertion of the clip. Most inventors would just avoid the distortion problems by using thicker wires. As an example, the Ideal paper clip patented by Cushman & Denison Mfg, Co. in 1902 was one of the very few patents that survived the past hundred years. It is still sold only in a gigantic version to a dwindling customer base.

U.S. Pat. No. 4,949,435 was issued to Gary Michelson in 1990. The inventor came up with the bent-V arms (which appeared in the early 19th century as the Standard clip and the Ezeon clip) to reduce the distortion problem. But he failed to understand the intrinsic mechanism of his improvement. He stated that it is a technological advancement even though his design looked so much simpler. But when he proclaimed that the clip could lie flat regardless of the thickness of papers, he revealed his ignorance. This lack of understanding caused him to create a design that was functionally flawed. (Details on the flaw would be discussed at the end of the theory section.) He also tried to overcome the flaws by using thicker wire.

In 1936, the Clipiola Mfg. Co. patented a circular clip called the Nifty Paper Clip. It is also known as Kurly Klip or Spiral Clip. It was like a key ring but with all the wire staying on the same plane. In the summer of 2004, I wandered into a Walmart store and bought one box of these spiral clips because I was trying to find a better way to handle the loose-leaf papers. Within days, I came up with my version of a crisscross double spine paper clip.

The earliest paper clip to have the crisscross double spine design was probably U.S. Pat. No. 2,211,034 issued to S. Stern in 1940. The clip was designed in conjunction with some sheet metal to be clipped on file folders. Surprisingly, there were to only two

US patents (with the crisscross double spine design) issued since then: U.S. Pat. No. 4,523,354 issued to T. Tsukamoto in 1985, and U.S. Pat. No. 5,319,835 issued to Chung L. Chao in 1994. Theoretically, the double spine should give the clip extra strength while the crisscross design should give it extra capacity. Again, due to designing flaws, these prior arts failed to realize the distinct advantages of such a design. The larger capacity the inventors were boasting of was probably in the range of 30 to 40 sheets at best.

A patent with crisscross double spine design was issued in Japan in 2003. (See Japan patent # JP2003094871.) But it also utilized an additional flat surface as one of the clamping arms, which must be firmly attached to the wire part. It therefore belonged to a completely different category, and was not comparable to the present invention.

Another related invention that has the crisscross double spine design is currently under examination. Douglas P. Arduini filed a US Patent Application, US#20040064960, in 2002. I surmised that the spiral clip was what inspired him to create the crisscross design, because some of the alternative embodiments of his invention were double loops. However, he opted for a closed loop wire design, and that is where our inventions parted company.

Within six months, Arduini filed another application, US#20040172791. He must have realized that closed-loop wire was not practical. But most of the embodiments were simply the same designs as the precious application, except the closed loops were broken at one spot to qualify the clip as using one piece of wire with open ends. And he was still confined to the long-U arms design of the Gem clip, which indicated that he had no intention of competing with the binder clip in handling a thick stack of paper. He made the pair of arms almost equal in length, which would make it hard to handle during insertion. The rectangular shape of the long front arm might look clean right off the box, but once you applied the clip to a paper stack, it deformed easily and became obtrusive when you tried to leaf through the pages. Even though the clip did offer stronger clamping power than the Gem clip, it had a tendency to slip off a thick stack of papers. It seemed like, in the rush to file the Continuation-in-Part application, he did not quite tested the new designs out thoroughly, and failed to recognize that there was a problem.

The Cutter-Tower Co, of Boston, Mass. advertised an interesting double spine paper clip in 1909. It was somewhat related to an alternative embodiment of the present invention which I called the heart clip. The intended operation was for the user to push the two bent-tip arms away from the ring arm to create an opening for paper insertion. The two fingers were there to hold the ring arm back while the thumb pushes forward. Such an operation was clumsy at best, unless the ring arm was large enough. It would have being much easier if the ring arm was longer, as was in the case of the owl clip, which was patented in 19xx and still existed in today's market place. More details would be presented on Section D of the Alternative Embodiment.

I would like to discuss the mistakes of the prior arts further. But since most of these mistakes were causes by the failure of the inventors to fully understand the inner working forces of the clips, I believe that it is necessary to explain the theoretical background about the clip design first. And before we get to the next section, I also like to mention the PVC-coated Gem clip, which has become quite popular in the past decade. Even wire coat hangers had PVC coating, too. Most people seemed to love the added cosmetic value of the vivid colors, yet, hardly anyone ever noticed a very important utilitarian value the PVC coating had provided us.

### THEORIES BEHIND THE INVENTION

The steel wire has a rather low resilience compared to the sheet metal used in making the binder clip. It will yield and deform when force is applied on it. When the force is removed, only a portion of the deformation may be restored. That portion is what we called the resilience. By the way, the portion of deformation that caused the wire to bend in an undesirable form (rise above the surface of the paper) is what we usually referred to as the distortion. Since distortion is just another form of deformation, part of the distortion could be in the territory of resilience.

When you increased the number of sheets slowly, all wire clips would increase the force applying on the paper stack in the beginning. But when you got past a certain point, you would have pushed beyond the limit of resilience. It could be in the neighborhood of 10 to 25 sheets, depending on the thickness, length, and quality of the wire. When it happened, the molecular structure of the wire started to change and shift. It resulted in a significant reduction of the force exerted on the wire. Since this would happen intermittently as you continued to increase the thickness of the stack, the force exerted on the wire (or conversely, the counter-force exerted by the wire) would hover around a certain fixed value, and never quite got past much beyond that. However, through the intelligent design of the clip, you could make multiple sections of the wire to exert the maximum force independently, effectively doubled, tripled, or even quadrupled the strength.

To make a better paper clip, it is very important to balance or support all the forces that the clip applies on the paper stack. When one section of the wire applied force on a paper stack, it was essential to have another section of the wire on the other side of the stack to provide support, or counter-force. (That was the Newton's law.) Otherwise, the paper stack would yield and deform, and the clamping force will be significantly reduced. Most prior arts failed miserably on this count. On U.S. Pat. No. 5,319,835 filed by Chao, the arms on both side of the stack never crossed or ran along close to each other. That is an open invitation for the deformation of the paper stack.

Another way of balancing the forces is through the symmetry of the design. Most inventors had done well to approximate symmetry in their arts. However, in the case of a crisscross spine design, it might not be easy. It was indeed a problem an inventor needs to strive to resolve. As an example, human form was symmetrical while sitting down, but a person could not maintain the symmetrical form if the legs are crossed. One leg would always be on top of the other. Chao of U.S. Pat. No. 5,319,835 simply ignored this problem. On his patent drawings, he showed that both spines hugged the edge of the paper stack snugly and stayed perfectly straight. It was, in reality, physically impossible.

Tsukamoto of U.S. Pat. No. 4,523,354 did recognize the problem. He tried to bend the crisscross spines to go around each other, which only amount to much ado. It complicated the matter while achieved almost nothing. In fact, the clip became less stable because it ended up that neither spine was able to hug the edge of the paper stack snugly.

Next in the agenda for a better paper clip design is the reduction of distortion: that undesirable part of the deformation. The Gem clip had demonstrated to us that when the clip engaged the paper, the bights would try to maintain the same plane as the spine. And the bent-arms, unable to sink into the paper stack, would be pushed out. As a result, the bights and the upper arms would rise from the surface of the paper. It followed naturally that if we reduced the size of the bights, we would significantly cut down on the distortion. And when you minimized the bight of a bent-U bent arm, what you got was actually a surprisingly simple bent-V arm. (I call the minimized bights the elbows from now on.)

For a wire clip, the bent-V arms were very important sources of extra clamping power, especially when the upper arms were perpendicular to the spine. When such a clip was applied to a stack of papers, the tips of the bent arms would sink the deepest into the paper if no resistance were offered. While being pushed out of the paper surface, the wire tips, which had to travel a longer distance, would create extra sets of force and counter-force. These would naturally cause some distortion on the bent-arms. This distortion appeared in addition to the distortion of the elbows (minimised bights) and the upper arms, which could be minimized by the bent-V design, and also by the shortening of the long arms. But if the arms were rather short, the wire tips would become more likely to damage the paper surface since they were trying to point downward.

As a matter of fact, these extras sets of force and counter-force could only be realized through deformation or distortion on the bent- arms. It was indeed just a trade off. Therefore, it was a choice for the inventor to pick a compromise between stronger clamping power and less distortion. If least distortion was the goal, the bent-arm should be designed so that it would not try to dive into the paper surface with its wire tip pointing downward. This could usually be achieved by making sure that the bent-arm was perpendicular to the edge of the paper stack, or slightly passed that point. As the spine took up an angled position against the paper surface, the bent-arm would lie flat while the upper arm tried to sink into the paper surface. As it was being pushed out, the force would be exerted evenly throughout the entire section of the bent-arm. It would result in very little distortion on the bent arms.

The distortion caused by the rising elbows would still be there. It is just not as visible without the help of the distortion from the bent-arms. As the paper stack got thicker, and the straight spine was pushed to hug the edge of the paper stack tightly, the angle of the upper arms would be pushed closer to the perpendicular position against the spine. And the bent-arm effect (extra sets of force and counter-force plus distortion) would start to appear. The effect would not be pronounced since the angle changed only slightly.

If the stronger clamping power was the objective, care must be taken that, as the spine took up the angled plane, the tip of the bent-arm would try to sink the deepest into the paper surface. As it was being pushed out by the paper surface, the extra distance the tip end had to travel would create some deformation on the bent arm which would then translated into an independent set of force and counter force. And as the paper stack got thicker, the spine would take up a wider angle, and the deformation (and thus the strength of the extra forces) of the bent-arm would increase proportionally.

Even though bent-arms of the Gem clip were perpendicular to the spine, the bent-arm effect was most definitely present due to the distortion of the bights and upper arms. Whether the inventor of Gem clip understand this concept or not, he designed his clip to allow the two bent-arms to work independently. It could have effectively doubled the strength of the clip. But the strength was seriously discounted by the distortions of the long wire and the paper stack. It was quite amazing that, in the next hundred years, no inventor was able to challenge the dominant position of such a seriously flawed design.

Meanwhile, as the bent-arm was pointing somewhat downward to the paper surface, it became quite likely that its tip might rip the paper, especially if the bent arm was rather short. However, this problem could be mitigated by designing the clip with longer arms, as was shown in the case of Gem clip, or, by making sure that the wire ends were well rounded. An alternative way to approach this problem was to extend the bent-arms all the way to the spine, as was demonstrated by U.S. Pat. No. 5,329,672.

Michelson, of U.S. Pat. No. 4,949,435, designed his clip with a pair of bent-V arms. But he was not able to explain why it is better than the more complicated prior arts. Moreover, it was a mistake for him to use the pair of bent-V arms to work as force and counter-force against each other. They balanced each other out and failed to realize the extra clamping force that could have being doubled if they worked independently.

Silverberg, of U.S. Pat. No. 5,406,680, offered a simple but effective solution to Michelson's problem mentioned above. He bent the two upper arms closer together so that they crossed each other while the bent-arms became parallel to each other and perpendicular to the edge of the papers. With this little improvement, the bent-arms were able to work independently to provide stronger and more stable clamping forces. More details on Silverberg's design could be found in the alternative embodiment section under the title of Fish Clip.

Arduini of US application #20040172791, the latest contender of the crisscross double spine clip, also failed to recognize the power of the bent-arm. On the few embodiments that had open-ended straight arms, he simply turned the wire ends into tiny circles or peens, and failed to realize the extra clamping power that could have being harvested there.

### BRIEF DESCRIPTION OF THE FIGURES

The Figures are schematic depictions of embodiments of the invention.

FIGS. 1-3 are schematics illustrating the formation of one embodiment of the invention.

FIG. 4 is an alternative embodiment to that of FIG. 3.

FIG. 5 is an alternative embodiment to that of FIG. 4.

FIG. 6 is a photograph that schematically illustrates an alternative use of the invention.

FIG. 7 is a view similar to that of FIG. 3.

FIG. 8 is an enlarged end view of the embodiment of FIG. 3 as applied to a stack of paper and taken along the line A-A in FIG. 7.

FIGS. 9-10 schematically illustrate two additional embodiments of the invention.

FIG. 11 schematically illustrates use of the embodiments of FIG. 9 or 10.

FIG. 12 schematically illustrates another alternative embodiment to that of FIG. 10.

FIGS. 13-19 schematically illustrate additional embodiments of the invention.

FIG. 20 schematically illustrates an accessory for the invention.

FIG. 21 schematically illustrates the use of the accessory of FIG. 20.

FIGS. 22 and 23 are photographs comparing the invention to a conventional paper clip. FIG. 22 is a perspective side view, and FIG. 23 from an end view similar to that of FIG. 8.

### SUMMARY OF THE INVENTION

The invention may be summarized as a paper clip formed from a single length of bent wire, comprising: (a) a spine on an end of the clip, the spine lying in a vertical plane and having a variable vertical height (b) a pair of V-shaped longer arms formed in a first horizontal plane on a first side of the clip, each of the longer arms comprising a first section extending away from the spine and a second section bent back from the first section toward the spine at an acute angle to the first section; and (c) a single U-shaped shorter arm formed in a second horizontal plane on a second side of the clip, the first and second horizontal planes being separated from each other by the vertiacl height of the spine; in which the longer arms have sufficient length to cross underneath the U-shaped shorter arm. It is preferred but not required that at least a portion of the wire is coated.

In one embodiment, each of the longer arms extends transversely away from the spine in similar directions. In another embodiment, each of the longer arms extends transversely away from the spine in similar directions and each of the second sections lies perpendicular to the vertical plane of the spine (i.e. in the horizontal lower plane). In another embodiment, the spine comprises a pair of crossed arms, each crossed arm connecting one end of the U-shaped shorter arm to one of the V-shaped longer arms, the pair or crosssed arms forming the spine in a vertically expandable X-shape. In another embodiment, a portion of each longer arm lies laterally outward of the lateral width of the shorter arm, such that the spine accomodates a greater amount of vertical expansion.

The invention may be combined with a means for wedging the paper clip over an edge of a stack of loose-leaf paper. The preferred means is a piece of plastic sheet.

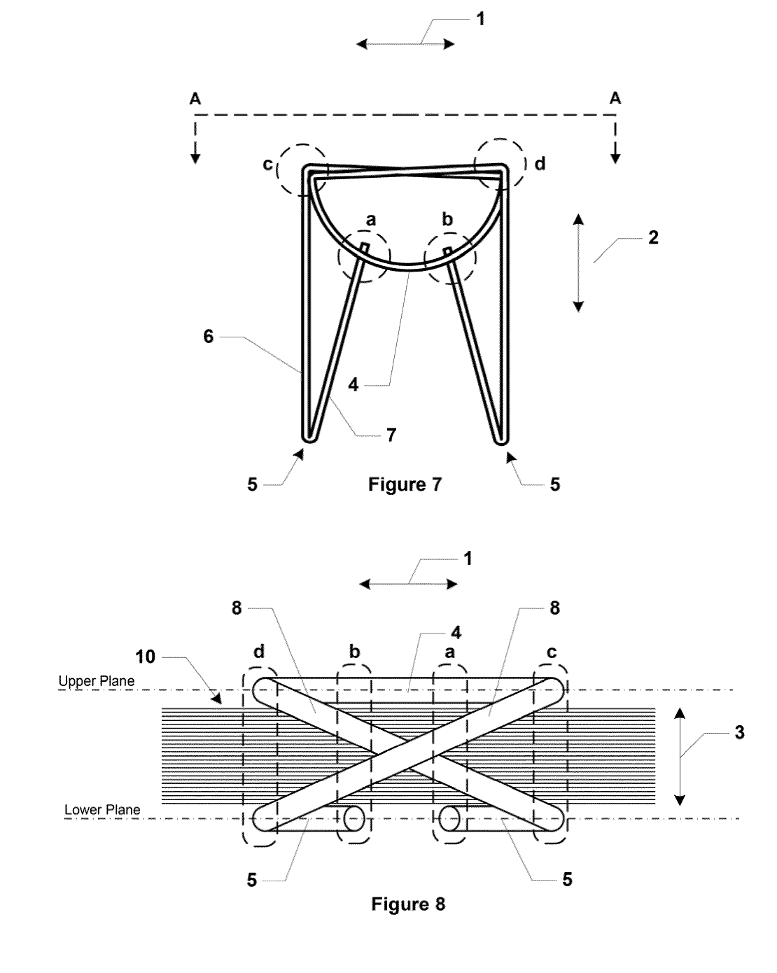

This description of the invention may be appreciated by reference to FIGS. 7 and 8. The lateral direction is indicated by the arrows denoted 1, the transverse direction by the arrows denoted 2, and the vertical direction by the arrows denoted 3. The upper horizontal plane and the lower horizontal plane are indicated by name. The U-shaped shorter arm is denoted by 4 and the two longer arms are denoted by 5, each longer arm comprising a first section 6 and a second section 7. The cross-arms in the spine are denoted by 8.

The dashed circles a-d illustrate positions where the invention provides maximum clamping (or holding) force on stack of paper 10, with the greatest amount of force being applied at locations a, b (where the longer arms cross underneath the U-shaped shorter arm) as compared to locations c, d (generally indicating where the endpoints of the U-shaped shorter arm lie above the portions of the longer arms adjacent the spine). The number, location, and distribution (transversely and laterally) of these positions provides the invention with its improved performance.

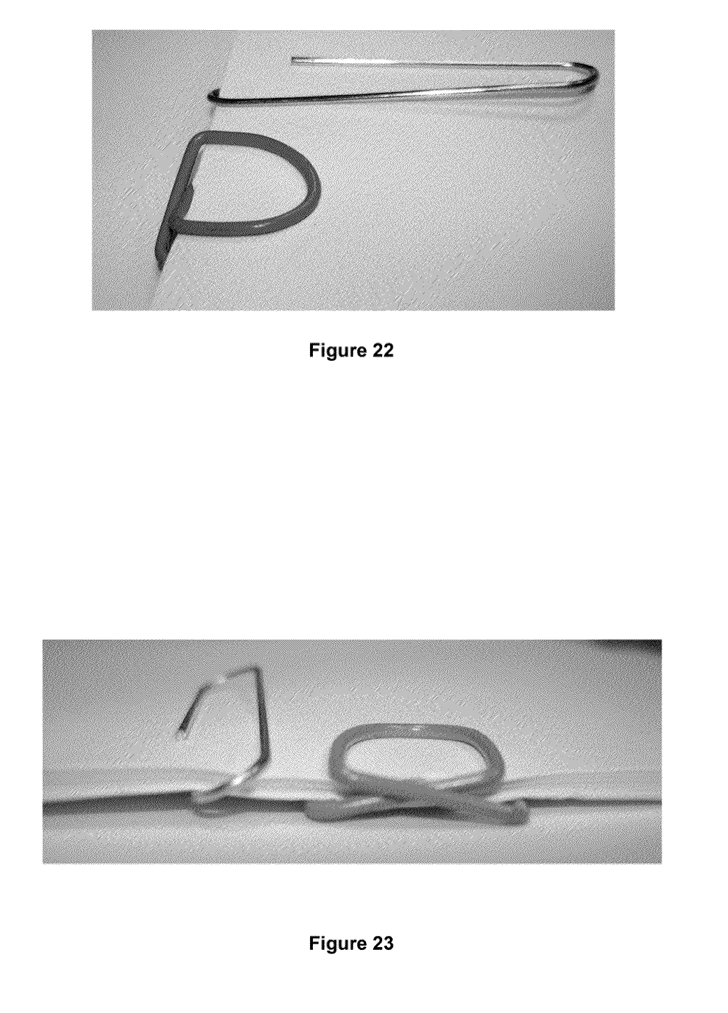

Indeed, the improved performance of the invention may be appreciated by reference to FIGS. 22 and 23, which are photographs comparing the invention to a conventional paper clip (Gem-type “Jumbo” smooth finish, Diversity Product Solutions #DPS40021) as applied to thirty sheets of 75 g/m2 (20 lb) white multipurpose paper (Boise-Cascade X-9 # 0X9001). It is clear that the inventive paper clip lies flat against the stack of paper and does not twist (i.e., lose gripping strength) itself (FIG. 22), nor does it twist the stack of paper to such a substantial degree as the conventional paper clip (FIG. 23).

### SPECIFICATION

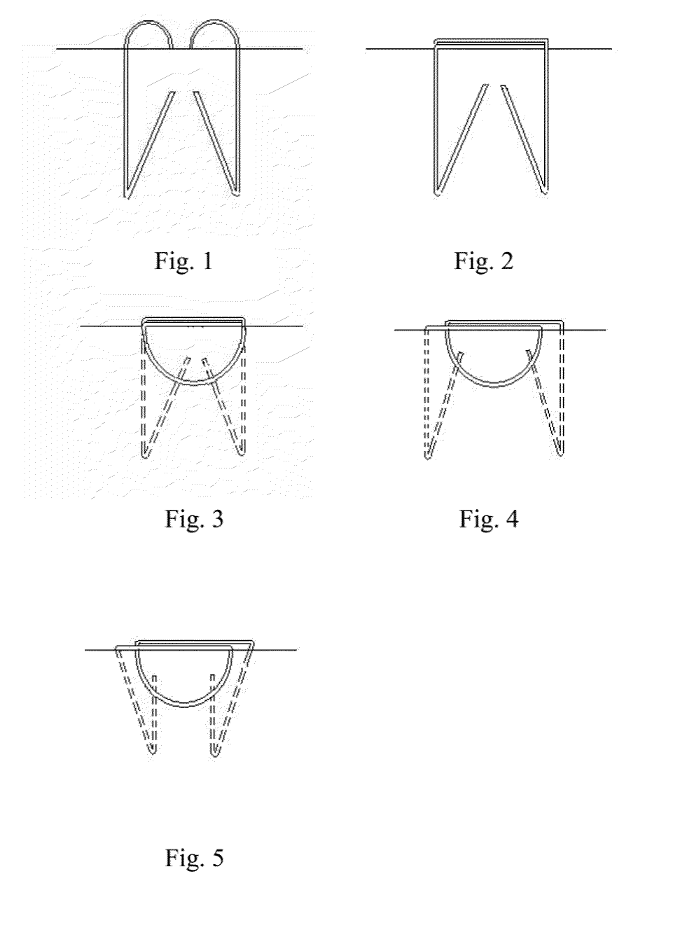

Armed with the understanding of these theories, we could now proceed to design a better clip. Since the clip was designed to challenge the binder clip, the symmetry theory dictated that we started with a pair of Gem clips, The first step was to convert a pair of long-U arms into medium-V arms, with the wire ends facing each other, as shown on FIG. 1. Long arms would only increase the cost and the distortion. By utilizing a pair of bent-V arm, we could ensure that the new clip would have strong clamping power with very little distortion, if we did not repeat the designing flaws of the prior arts.

Next, we converted the two separate spines into a pair of crisscross spines. The crisscross design allowed us to have longer spines and increase the capacity of the clip. We extended the spines just so that the two pairs of upper arms lined up perfectly. This was to provide support (force and counter-force) for each other, and prevent the deformation of the papers. Then, we made the spine straight so that at least one of the spines would hug the edge of the paper stack snugly and create a cleanly defined clipping, as shown on FIG. 2.

The final step was to combine the rest of the two pieces of wire (the other two long-U arms on the other side) into one. Here, we created one short-U arm instead, as shown on FIG. 3. This would conclude the preferred embodiment of the present invention. There were many reasons to have a short-U design here. First of all, with this design, the clamping arms had to be longer on one side than the other side. It would make the paper insertion easier. And it was much better, cosmetically and ergonomically, to have the short U on the front side. It had a small foot print and was easier to handle during insertion.

Notice that the spines could easily be extended further to create a super-capacity clip. When the clip was applied to a thick stack of papers, the position of the bent-arms would shift to the center. The slightly longer spine would be compensated by the shilling of the arms and allow the pair of upper arms to be supported by the U-arm on the other side of the paper stacks shown on FIG. 4. This was an option no prior art was able to offer. Also, the upper arms could be bent a little further so that the bent-arms were perpendicular to the edge of the paper stack, as shown on FIG. 5. This alternative embodiment traded some clamping power for a little less distortion.

Since the bent arms derived their extra clamping force by being pushed out of the paper surface, care must be taken while designing the clip to make sure this happened as the thickness of the paper stack increased. Silverberg's clip had the bent arms placed perpendicular to the straight spine. It is an attempt to eliminate distortion at the cost of some clamping power. As the spine took up an angled position against the paper stack, the tips of the upper arms and the entire bent-arms would sink to the same depth if resistance were not there. As the arms were pushed out, deformation occurred only on the upper arms. The bent-arms just lied flat against the paper surface. It resulted in very little distortion, although the clamping force was reduced significantly, since the bent arm effect was eliminates.

Some inventors mistakenly assumed that a flat bottom U arm (that looked almost rectangular) was better than the round bottom U-shaped arm. (Cases in point: U.S. Pat. No. 4,523,354, U.S. Pat. No. 5,406,680, and US application #20040172791.) They probably figured that as you leafed though the pages, the straight bottom of the front arm would create a better-defined folding line. But this would not be the case usually. When you used two or three of these clips on the same edge of the paper stack, the straight bottoms of the rectangular U-arms rarely lined up straight due to distortion This would make it even harder to define a straight folding line. Even if only one clip were applied on the upper left corner of a paper stack, the long rectangular arm would still be an eyesore and make the leafing through of the pages harder.

As I had pointed out earlier, the curved shape of the U-arm would give that wire section a little extra strength. The rectangular shaped U-arm created three sections of straight wire that would easily subject to distortion, especially when the arms were relatively long.

Lastly, it is a very important for the U-arm to be shorter than the bent-arms. The changing thickness of the paper stack could shift the position of the bent arms so that the two pairs of straight upper arms would not line up perfectly. But as the arms shifted toward the center of the clip, the short-U arm would always be there on the other side of the paper stack to provide support. So, no deformation of the paper would occur as a result of the offset position of the upper arms. The owl clip, designed to make the wire ends imitate the owl's eyes (and for easier insertion) had a longer flat-bottom U arm. It was not able to support the arms on the other side of the paper stack. It would result in the deformation of the papers and significantly reduced the clamping force.

To sum it up, this preferred embodiment used a piece of steel wire to create a symmetric clip with a well-balanced inner working forces that would produce a strong clamping power with a minimal amount of distortion while being used on a very thick stack of paper.

### OPERATION

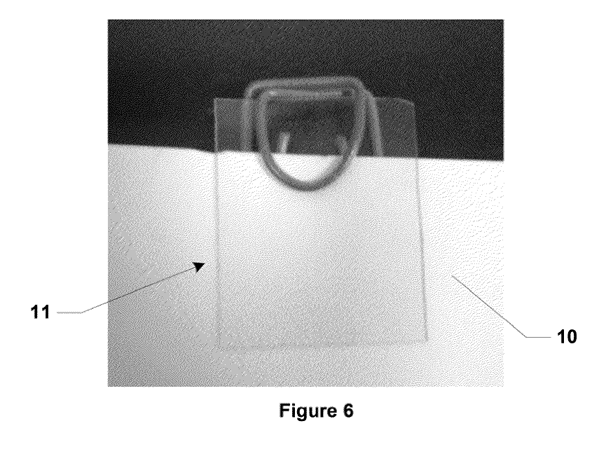

Referring to FIG. 6, to apply this paper clip to a stack of paper, a small sheet of thin vinyl (or cardboard) 11 of about one and a half by two inch rectangle would make the job a little easier. (I would call it the vinyl guide.) The first step is to insert the flexible vinyl guide 11 into the clip, which should be rather easy. Next, hold the paper stack 10 with one hand near the spot where the clip would be inserted, and use the other hand to position the open end of the vinyl guide 11 over the top edge of the paper 10. The short-U arm of the clip 4 should be facing you since it is supposed to go on top of the stack, as shown on FIG. 6. Next, gently push the clip down so that the tips of the bent-V arms 5 go under the stack 10 while the vinyl guide 11 is bent slightly but stays on top of the stack. Next, push the clip toward the paper stack swiftly, remove the vinyl guide once the clip has engaged the paper. In this operation, the vinyl guide 11 serves as a wedge to open up the clip and to guide the paper stack in. The final step is to straighten out the clip and make sure that the inner portion of spine cross members 8 are in full contact with the edge of the stack.

It is not always necessary to use a vinyl guide. Your thumbnail would work almost just as well, as long as you did not trim it too deep. To insert the clip with your thumbnail, hold the clip between your thumb and middle finger. The tip of the thumbnail should go under the tip of the short-U arm while the middle finger press against the spines of the clip. Next, position the elbows of the bent-arms under the paper stack, lift the short-U arm gently with your thumbnail while you pushing the clip toward the paper with the middle finger in a swift motion. You do not have to worry about how high you should lift the short-U arm. Just lift it slightly, push the clip in, and let the thumbnail guide the paper into the clip. In fact, the operation is a lot easier than it sounds.

It should be noted that due to the low resilience of the steel wire, a clip that had being used on a thick stack of paper would not be able to perform the same task on a thin stack of paper. You could simply press the clip to make it flatter. Or, you could use a pair of long-nosed pliers to rejuvenate the clip by carefully opening it up, bending the arms backward, and return them to the original positions. (Note that it is not necessary to open up the clip all the way, just so that you can push the arms back in the other direction.)

Meanwhile, even though the binder clip-still offers a strong clamping power, the slightly weaker clamping power of the present invention could turn out to be a good thing. When you used two of these clips to create a small notepad, you could write down phone number or address on the first page, pull it out, and give it to a friend or business associate. You just had to hold down the rest of the pages close to the clip with one hand while you pulled the first page out with the other hand so that the next few pages did not come out with the first page. You did need to replenish the note pads before you pull out too many sheets and the stack become too thin for the clip to hold tightly.

At this point, the new clip was almost ready to challenge the binder clip in the handling of a very thick set of papers. It could expand or shrink with the changing thickness of the paper stack, with hardly noticeable distortion, It could create a compact notepad that works and feels like a legal pad. It is strong enough to hold up to 100+ sheets of papers. It did not have the annoying wire handles to deal with when you leafed through the notepad. It is almost flawless for clipping a set of papers on the upper-left corner. However, there remained one major hurdle for it to overcome before it could become a real contender in a market dominated by the binder clip.

I had tested this clip by using two of them to create a small (2.75″×4.25″, one-eighth of the letter size paper) but thick (over 60 sheets of papers) notepad and carrying it around in my pocket for days at a time. The clips seemed to manage to slip out of the notepad quite often. It is a problem that had bothered me for quite some time. I eventually developed a locking mechanism to keep the clips secured on the notepad.

The locks were actually just tiny rectangular vinyl sheets that were glued to the backboard close to the edge where the clips were to be applied. The thickness of the lock rectangle should be between half and full Thickness of the wire. When a clip was being inserted, the bent-arms would glide over the rectangles. They usually produced a clicking noise as they cleared the rectangle. The noise also signaled the engagement of the lock. The tiny piece of vinyl would now prohibit the bent-V arms from going back in the other direction. This mechanism could do a decent job of keeping the clip from slipping out. But it also created new problems. It was necessary to slide a vinyl (or cardboard) guide underneath the bent arms to disengage the lock before you tried to remove the clip. I always seemed to forget to do that, and end up using excessive force to deform the clip, or dislodge the lock.

This lock design also put restrictions on where the clip could be applied. It could be quite an inconvenience, unless you did not plan on adjusting the paper stack often.

The preferred solution to this problem is the use of PVC coated wires to form the paper clip of the invention, not because they give the clip its beautiful colors, but because they provide additional friction force that would secure the grip. When the PVC-coated clip was applied to or disengaged from a thick set of paper, there was a distinct popping noise that came with the action. It was actually the telltale sign that the friction force was at work there. Nobody ever noticed its existence because the Gem clip usually did not exert enough force to make it recognizable. Since then, T was able to carry a small 100+ sheet notepad (without the locks) in my pocket for weeks without having to reapply or readjust the clips. (I used the plus sign here to indicate that it included a backboard.)

### ALTERNATIVE EMBODIMENT

Special situations often dictated that certain qualities of the clip be emphasized. The preferred embodiment described above, which I shall refer to as the double clip, might not the most desirable design for all occasions. Specific embodiments are needed to cater to each of the niche markets.

A. Fish Clip

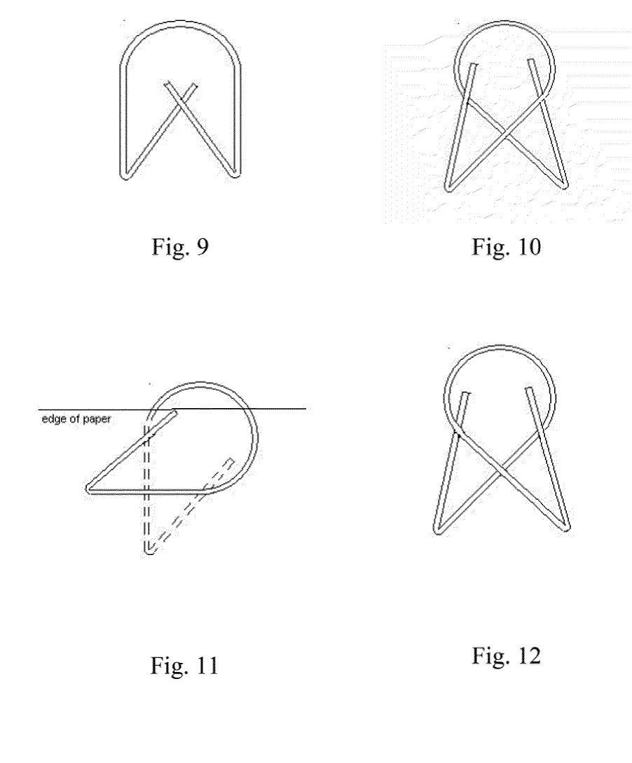

For the absolute minimalists who demanded the lowest cost, or those who handle the paper file storage and retrieval, I had an alternative embodiment that would fulfill their special needs. It started out with roughly half the length of wire from a single Gem clip, but with bent-U arms converted to bent-V arms, as shown on FIG. 9. At this stage, it looked a lot like Michelson's clip, and with exactly the same designing flaws as was pointed out in the theory section. The solution to this problem was rather simple: just bend the two arms toward each other and create multiple sets of balanced working force, as shown on FIG. 10.

Silverberg, of U.S. Pat. No. 5,406,680, came up with somewhat similar clip in 1993, except that the spine of his clip was straight. It was probably the only prior art that did not violate the theories of clip design discussed earlier. It is too bad he did not realize the superiority of that design, and picked the flat bottom U-arms as his preferred embodiment. Obviously, he failed to fully understand the working mechanism of his own creations.

There is one big problem he failed to approach, though. When the clip was applied to a thick stack of papers, it had a tendency to slip off. It is a problem that could be easily fixed with the PVC coating. Maybe he never intended for the clip to be used on a thick stack of papers, just as most of the prior art inventors did. But the failure to recognize and address the problem certainly made his claim of larger capacity questionable.

Silverberg's clip looked quite similar to the fish clip; the spine designs (straight versus ring shaped) made a whole world of difference. As I had point out earlier, it is often just a trade off between distortion and clamping power. As the straight spine of Silverberg's clip was pushed to hug a stack of papers tightly, the major deformation occurred as the upper arms were bent backward closer to the perpendicular. This deformation occurred mostly at the tiny joints between the spine and the upper arms. It resulted in the shifting of the molecular structure mostly at the joint. The lacking in visible deformation also meant that less significant sets of force and counter-force were generated. The tensional deformation was the only deformation that would generate the set of force and counter-force.

The small footprint of the fish clip made it perfect for creating a small notepad. The clip could be applied at an angle so that the front arm is parallel to the edge of the stack, as shown in FIG. 11. Clipping the paper stack this way allows the clips to be used like binder clips, making it possible to create small notepads (using two or three clips on one edge of the paper stack) with very little unviewable area clamped down under the clips. It's a feat other metal wire paper clips were never able to achieve, let alone with such short wire and small footprints (or intrusions).

Meanwhile, people did not always use clips to create notepads. Oftentimes, they applied one clip just to keep the paper stack together. Actually, that is how Gem clips were used most of the time. The fish clip can be used this way very effectively, with stronger clamping power, smaller footprint, and less distortion.

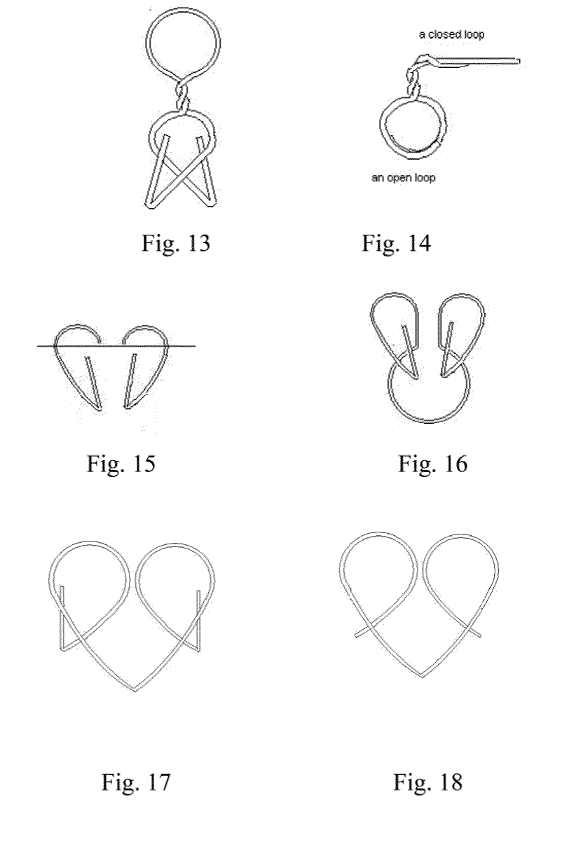

By the way, the fish clip has an almost identical twin, as shown on FIG. 12. The only difference between them is how their arms are crossed. In the Western world, people read from the left to the right. They tend to apply the clip on the upper left corner, and use left hand to leaf through the pages. Therefore, the fish clip was designed with the arms bent to the left, as shown on FIG. 10. In the Eastern world, people read from the right to the left, so, the arm position should be reversed. They could be used together to create a stronger and more symmetrical clipping. The pairing of the twins led me to another alternative embodiment, the heart clip, discussed further below.

Even though the overall size of the fish clip is much smaller, the insertion of the clip can be quite easy, if you learn how to do it the right way. With the fish clip, you do not need to open up the arms—it is done automatically. Just rest the stack of paper inside the open end of the crossed arms at about 45 to 60 degrees, twist the clip slightly while you push the clip forward to receive the paper, as shown on FIG. 11, and the arms will guide the paper in. If the stack of the paper is too thick to fit in between the open ends of the crossed arms, you are overreaching beyond the recommended capacity of the clip.

After the clip had been used on a thick stack of paper, it might have trouble clipping a thinner stack of paper. However, you can easily rejuvenate the clip by opening up the crossed arms, bending them the other way slightly, and pushing them back into the crisscross position again.

B. Hanging Fish Clip

Sometimes, you may wish to hang a small notepad somewhere visible to remind you of things that you need to do. On the other hand, you may wish to hang a greeting card somewhere in the house. An easy way to do this is use a fish clip with a ring on top. To create such a clip, a full-length Gem clip wire was required. The mid-section was used to create a ring by bending it into a smooth almost round circle, that is, until the two straight ends cross each other almost perpendicularly. Now, twist the two arms tightly together for a full 360 degrees. Bend the rest of the wire to form the fish clip, as shown on FIG. 13.

It was noticed that since the spine of the hanging fish clip was now a twisted wire, some of the clamping power was lost. However, since it was designed to hang only light object, it could still perform its intended function quite well. Besides, it pointed the way to a couple of alternative designs, as shown in sections C and E below.

C. Pen Clip

It would be nice to hang a pen together with the hanging notepad, so you do not have to search for one when you want to write something on the pad. Fortunately, a simple modification on the hanging fish clip produces a clip that would work nicely.

To make the pen clip, we could start with the ring first, just like in making the hanging fish clip. However, we would twist the wire 450 degrees, and bend the two end sections into another ring. Thus, the second ring, which was perpendicular to the first one and was composed of two curved arms, would be used to accommodate the pen by embracing it. In addition., since the two rings together were rather intrusive, we would bend it 90 degrees at the elbow. The result was shown on FIG. 14. This would be the preferred embodiment of the pen clip.

Incidentally, a pen equipped with such a pen clip could be hung and stored inside the rings of a 3-ring binder. The space inside the rings of a ringed binder was a piece of undeveloped real estate. Nobody ever tried to make any use of it. Most name brands of zippered ring binder would provide elastic pen loop at the edge of the binder cover, which could be a source of annoyance sometimes. Since most of the rings of ring binder are three quarter inch in diameter or larger, there is plenty of room for a companion ball pen to reside in there. I am certain that most users would appreciate this little change of pen placement.

D. Heart Clip

When the twin fish clips were clipped next to each other, they created an image that bore a slight resemblance to the symbolic heart, as shown on FIG. 15. The heart was an internationally recognized symbol of caring. Its desirable presence could be seen on a variety of merchandise, especially when it came close to the Valentine's Day. There were heart shaped clips available on the market, but they were all made of sheet metal or plastic at rather high prices. Nobody had ever tried to create a heart shaped clip made of steel wire entirely.

My first rendition of a heart clip was to transform the two anus on the backside of a pair of fish clips into a ring, as shown on FIG. 16. This was a slightly flawed design and it looked more like a broken heart instead. However, since it led me to a new kind of clip design, I presented it here mainly for future references.

Instead of joining the back end wires, the front end wires could be joined to create a perfect heart shape, while keeping the wonderful functionality of the bent-arms on the back, as shown on FIG. 17. Notice here that the bent-arms were designed to be shorter than the heart shaped front arm, because it would make the insertion easier and save on material.

Since the heart clip was designed mainly for its sentimental value, capacity was not the main concern; the bent arms could be eliminated to save on cost as shown on FIG. 18. People could express that they cared deeply by attaching a heart clip to a greeting card on various occasions. To apply the clip, you just hold the clip with your thumb and two fingers, with the tip of the thumb resting on the top part of the heart. Then, you place the bottom of the heart on the edge of the greeting cad and push the two bent-arms down slightly with your thumb while shoving it toward the card. Oftentimes, you can just slide the card into the heart clip without the help of the thumb.

By using the PVC-coated wire, different colors of heart clip could be used to express different mood of caring. The heart clip could be used to bind a small stack of paper, too.

E. Ring Clip

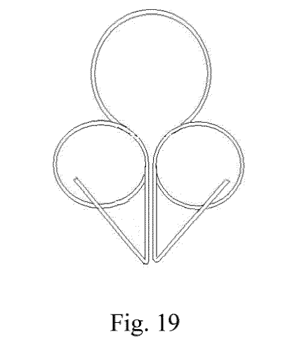

To improve the clamping power of the hanging clip, it was necessary to utilize the extra strength of a double spine design. Luckily, a minor adjustment on the failed first rendition (See FIG. 16) of the heart clip would provide a good starting point for this purpose. By extending the curvature of the spines until the bent-arms pointed the other way, as shown on FIG. 19, the two spine rings could provide very strong clamping power while the ring arm became the hanging ring.

This clip was designed with small clamping rings. It was intended for use on greeting card or cardboard only. It could create a hanging notepad in a different way. After all, the prime objective of the present invention was to facilitate the handling of loose-leaf papers. In the next paragraph, I would show you how to make a 3″×5″ hanging notepad.

To begin with, you need a piece of 3″×5″ cardboard as the backboard. If you do not have one already, you can cut one out of a cereal or cookie box. Next, applies a ring clip to the center of the 3″ side of the cardboard. Put the stack of 3″×5″ paper on top of the cardboard. Straighten out the edges of the stack that include the backboard. Apply two double clips to the paper stack on both sides of the ring clip. In addition, there you have it, a very sturdy hanging notepad you can display at a visible spot to remind you of the important things you need to do.

The ring clips could also be used to attach a legal notepad to a 3-ring binder. Apply three ring clips to the left edge of the backboard of a legal pad. Make sure you position the ring clips at the appropriate spots, and you have a legal pad that can be carried in a 3-ring binder. You can also create your own notepad with double clips, and then, use the ring clips to attach the notepad to a 3-ring binder.

To apply the ring clip, it is easier to work from the bent arm side. Hold the clip with one hand, place the tip the bent-arms on the edge of the card or cardboard, extend the forefinger or middle finger of the other hand to support the arm tips on the other side of the cardboard. Now gently press the clip down with your thumb to push the rings under the cardboard and move the rings to engage the cardboard at the same time. After you push it in all the way, the clip would provide a very strong clamping power to hold the cardboard securely.

The ring clip could be used in many different ways. For example, retailers could use it to display flat items on the rack. Manufacturers often packaged their merchandise in plastic bubble that was scaled to a piece of cardboard. It usually had a hole on the top that shaped like a flying saucer. Retailers used the hole to hang the merchandise on the display panel. However, this elongated hole could easily be tipped open by careless shoppers. It would be quite easy to hang it back on the display panel if you apply a ring clip to the cardboard.

F. Improved Clip Lock

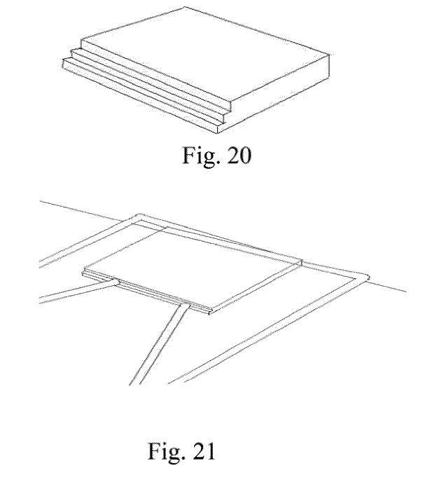

The idea of sequential lock could be used to improve the clip locks. Instead of a simple piece of vinyl triangle, the lock could be made to shape like a staircase, as shown on FIGS. 20 and 21. Each step would be about half the thickness of the wire. These sequential steps would allow the bent-arms to engage the lock at the various steps, and to secure the clipping even if the bent arms were slightly deformed for whatever reasons. Meanwhile, as the wire tips were resting on a step or two above the paper surface, they would exert slightly extra clamping power without adding any extra distortion to the joints.

The slightly raised wire tips at the center of the double clips would hardly be noticeable. This could be a very efficient and non-intrusive way to improve the clamping power of the paper clip. Such special clip locks could turn out to be faithful companion for the double clips in creating notepads or reports that did not need readjustment often.

The preceding discussion employs various preferred embodiments of the invention for purposes of illustration only, as the full extent of the invention is defined only by the following claims.

1. A paper clip formed from a single length of bent wire, comprising:
a) a spine on an end of the clip, the spine lying in a vertical plane and having a variable vertical height;
b) a pair of V-shaped longer arms formed in a first horizontal plane on a first side of the clip, each of the longer arms comprising a first section extending away from the spine and a second section bent back from the first section toward the spine at an acute angle to the first section; and
c) a single U-shaped shorter arm formed in a second horizontal plane on a second side of the clip, the first and second horizontal planes being separated from each other by the vertical height of the spine;
in which the longer arms have sufficient length to cross underneath the U-shaped shorter arm; and in which the spine comprises a pair of crossed arms, each crossed arm connecting one end of the U-shaped shorter arm to one of the V-shaped longer arms, the pair of crossed arms forming the spine in a vertically expandable X-shape.

2. The paper clip of claim 1, in which at least a portion of the wire is coated.

3. The paper clip of claim 1, in which each of the longer arms extends transversely away from the spine in similar directions.

4. The paper clip of claim 1, in which each of the longer arms extends transversely away from the spine in similar directions and each of the second sections lies perpendicular to the vertical plane of the spine.

5. (canceled)

6. The paper clip of claim 1, in which a portion of each longer arm lies laterally outward of the lateral width of the shorter arm, such that the spine accommodates a greater amount of vertical expansion.

7. The paper clip of claim 1, in combination with a means for wedging the paper clip over an edge of a stack of loose-leaf paper.

8. The paper clip of claim 1, in combination with a piece of plastic sheet for wedging the paper clip over an edge of a stack of loose-leaf paper.

9. A method of forming a paper clip from a single length of wire, comprising bending the wire into a single U-shaped shorter arm, a pair of V-shaped longer arms crossing underneath the U-shaped shorter arm, and a pair of crossed arms connecting one end of the U-shaped shorter arm to one of the V-shaped longer arms to form an expandable X-shaped spine.

10. The method of claim 9, further comprising coating at least a portion of the wire.

11. The method of claim 9, further comprising extending each of the longer arms transversely away from the spine in similar directions.

12. The method of claim 9, further comprising extending each of the longer arms transversely away from the spine in similar directions; and each of the second sections lies perpendicular to the vertical plane of the spine.

13. The method of claim 9, further comprising providing the spine with a pair of crossed arms, connecting each crossed arm between end of the U-shaped shorter arm and one of the V-shaped longer arms, such that the pair of crossed arms form the spine in a vertically expandable X-shape.

14. The method of claim 9, further comprising providing the spine with a greater amount of vertical expansion by extending a portion of each longer arm laterally outward of the lateral width of the shorter arm.

15. A method of forming a paper clip from a single length of wire, comprising:
a) forming a spine having a variable vertical height in a first plane;
b) extending a single U-shaped shorter arm from the spine on a first side of the paper clip in a second plane substantially perpendicular to the first plane;
c) extending a pair of V-shaped longer arms from the spine on a second side of the clip in a third plane substantially parallel to the second plane, by extending a first section of each longer arm away from the spine with sufficient length to cross underneath the U-shaped shorter arm, then acutely angling a second section of each longer arm back from the first section toward the spine; and
d) separating the second and third planes from each other by variably vertically expanding the spine.

16. The method of claim 15, further comprising coating at least a portion of the wire.

17. The method of claim 15, further comprising extending each of the longer arms transversely away from the spine in similar directions.

18. The method of claim 15, further comprising extending each of the longer arms transversely away from the spine in similar directions; and each of the second sections lies perpendicular to the vertical plane of the spine.

19. The method of claim 15, further comprising providing the spine with a pair of crossed arms, connecting each crossed arm between end of the U-shaped shorter arm and one of the V-shaped longer arms, such that the pair of crossed arms form the spine in a vertically expandable X-shape.

20. The method of claim 15, further comprising providing the spine with a greater amount of vertical expansion by extending a portion of each longer arm laterally outward of the lateral width of the shorter arm.
